(19) United States
(12) Patent Application Publication
(10) Pub. No.: US 2025/0060390 A1
(43) Pub. Date: Feb. 20, 2025

(54) Attachable Wind Detection Device

(71) Applicant: John Pahrmann, Poulsbo, WA (US)

(72) Inventor: John Pahrmann, Poulsbo, WA (US)

(21) Appl. No.: 18/936,710

(22) Filed: Nov. 4, 2024

Related U.S. Application Data
(63) Continuation-in-part of application No. 18/365,959, filed on Oct. 26, 2023, now Pat. No. 12,181,488.
Application No. 18/365,959 is a continuation of application No. 17/461,905, filed on Aug. 30, 2021, now Pat. No. 11,733,261.
Application No. 17/461,905 is a continuation of application No. 17/376,648, filed on Jul. 15, 2021, now abandoned.
Application No. 17/376,648 is a continuation of application No. 17/315,923, filed on May 10, 2021, now abandoned.
Application No. 17/315,923 is a continuation of application No. 17/183,296, filed on Feb. 23, 2021, now abandoned.
Application No. 17/183,296 is a continuation of application No. 16/723,739, filed on Dec. 20, 2019, now Pat. No. 10,928,415.
Application No. 16/723,739 is a continuation of application No. 16/139,822, filed on Sep. 24, 2018, now Pat. No. 10,514,388.
Application No. 16/139,822 is a continuation of application No. 16/045,664, filed on Jul. 25, 2018, now abandoned.
(63) Continuation of application No. 29/879,165, filed on Jul. 3, 2023.
(60) Provisional application No. 62/898,982, filed on Sep. 11, 2019.
(60) Provisional application No. 62/536,952, filed on Jul. 25, 2017.

(51) Int. Cl. G01P 13/02; A01M 31/00; A61J 9/04; B05B 11/06; F41B 5/14; F41G 3/08; G01P 13/00

(52) U.S. Cl. CPC G01P 13/02; F41G 3/08; G01P 13/0006; A01M 31/00; A01M 31/008; A61J 9/04; B05B 11/06; B05B 11/062; F41B 5/148; G01P 13/0093

(57) ABSTRACT

A device for an attachable wind detector that affixes directly to hunting equipment, outdoor gear, headgear, or clothing, allowing for wind detection without unnecessary hand movements. In an embodiment, the wind detection device comprises an enclosure filled with powder or liquid, an enclosure holder, a swivel, and an attachment device, and a dispensing tube, designed to be attached to hunting equipment, outdoor gear, outdoor structures, headgear, or clothing, wherein pressing on the outside of the device causes a puff of powder or vapor to be dispensed into the air, allowing the user to determine wind direction.

### CROSS-REFERENCE TO RELATED APPLICATIONS

The following patent applications are expressly incorporated herein by reference in their entireties:
18/365,959
17/461,905
17/376,648
17/315,923
17/183,296
16/723,739
62/898,982
16/139,822
16/045,664
62/536,952

### BACKGROUND

### Field of the Art

The disclosure relates to the field of wind detection in outdoor activities, and more particularly to a hands-free, attachable wind detection device for such activities.

### Discussion of the State of the Art

In the field of hunting, hunters often spend hours or days tracking their prey forgoing modern luxuries such as running toilets, showers, clean shaves, or fresh laundry. This generally leads to a very dirty and smelly hunter tracking an animal such as deer, which is a very scent-sensitive creature. Wind direction can make or break a hunt; if a smelly hunter is positioned upwind of his prey, his scent can tip off his prey and run away thus ending a long hunting trip with no reward.

Hunters then have a need for wind speed and direction detection without removing their hands from their hunting equipment (e.g., bow, rifle). Common wind detectors are a simple squeeze bottle with talcum powder that can be kept in the hunters' pockets. This remedy requires the hunter to remove his hand from the hunting equipment, reach into the pocket, grab the bottle, pull it out of the pocket, squeeze it, and then place the bottle back into the pocket before he places his hand back on his hunting equipment. Any one of these movements can spook the prey and end the hunt with no reward.

Similarly, in other outdoor activities like golf, archery, target shooting, kite flying, and other activities, wind often plays an important role in success in the activity. As with hunting, in sports and other outdoor activities involving an airborne or projectile, accounting for the direction and speed of the wind can make the difference as to whether the object moves as intended or the projectile hits its target. Especially where decisions must be made quickly, quantitative measurements are not necessarily needed. Instead, a quick qualitative indication is often sufficient.

What is needed is a means to provide a wind detection device that attaches directly to a piece of hunting equipment, outdoor gear, headgear, or clothing, providing a quick and easily-accessible means for checking for wind direction.

### SUMMARY

Accordingly, the inventor has conceived, and reduced to practice, a device for an attachable wind detector that affixes directly to hunting equipment, outdoor gear, headgear, or clothing, allowing for wind detection without unnecessary hand movements. In an embodiment, the wind detection device comprises an enclosure filled with powder or liquid, an enclosure holder, a swivel, and an attachment device, and a dispensing tube, designed to be attached to hunting equipment, outdoor gear, outdoor structures, headgear, or clothing, wherein pressing on the outside of the device causes a puff of powder or vapor to be dispensed into the air, allowing the user to determine wind direction.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is an illustration of an exemplary wind detection device according to a preferred embodiment of the invention, illustrating device design for attachment.

FIG. 2 is an illustration of an exemplary wind detection device according to a preferred embodiment of the invention, illustrating a hunting bow with wind detection device attached.

FIG. 3 is an illustration of an exemplary method diagram according to a preferred embodiment of the invention, illustrating use of wind detection device.

FIG. 4 is an illustration of an exemplary wind detection device according to a preferred embodiment of the invention, illustrating use of wind detection device attached to surface of a hunting bow.

FIGS. 5A-5C are illustrations of a preferred embodiment having a circular frontal cross-section, an ovular side cross-section, and showing a mounting structure and mounting receiver.

FIG. 6 shows an aspect in which the device is attached through a thin object such as a hat or piece of clothing using magnets.

FIG. 7 shows an aspect in which the device is attached by a hook, post, or pin placed into a hole.

FIG. 8 shows an aspect in which the device is attached by a clip placed into a slot.

FIG. 9 shows an aspect in which the device is attached by a hook and loop fastener (commonly known as velcro, and often associated with the brand name Velcro™).

FIG. 10 shows an aspect in which the device is attached by a threaded screw mechanism.

FIG. 11 shows an orthogonal front view of an exemplary embodiment of a wind detection device with a swiveling semi-circular groove-type bottle holder and attachment device.

FIG. 12 shows an exploded orthogonal front view of an exemplary embodiment of a wind detection device with a swiveling semi-circular groove-type bottle holder and attachment device.

FIG. 13 shows a partially-exploded side view of an exemplary embodiment of a wind detection device with a swiveling semi-circular groove-type bottle holder and attachment device.

FIG. 14 shows a partially-exploded orthogonal rear view of an exemplary embodiment of a wind detection device with a swiveling semi-circular groove-type bottle holder and attachment device.

FIG. 15 shows an orthogonal front view of an alternate exemplary embodiment of a wind detection device with a swiveling semi-circular groove-type bottle holder and attachment device.

FIG. 16 shows an orthogonal rear view of an alternate exemplary embodiment of a wind detection device with a swiveling semi-circular groove-type bottle holder and attachment device.

FIG. 17 shows an orthogonal front view of an alternate exemplary embodiment of a wind detection device with a swiveling semi-circular groove-type bottle holder and attachment device.

FIG. 18 shows an orthogonal rear view of an alternate exemplary embodiment of a wind detection device with a swiveling semi-circular groove-type bottle holder and attachment device.

FIG. 19 shows an orthogonal front view of an alternate exemplary embodiment of a wind detection device with a swiveling semi-circular groove-type bottle holder and attachment device.

FIG. 20 shows a side elevation view of an alternate exemplary embodiment of a wind detection device with a swiveling semi-circular groove-type bottle holder and attachment device.

### DETAILED DESCRIPTION

The inventor has conceived, and reduced to practice, a device for an attachable wind detector that affixes directly to hunting equipment, outdoor gear, headgear, or clothing, allowing for wind detection without unnecessary hand movements. In an embodiment, the wind detection device comprises an enclosure filled with powder or liquid, an enclosure holder, a swivel, and an attachment device, and a dispensing tube, designed to be attached to hunting equipment, outdoor gear, outdoor structures, headgear, or clothing, wherein pressing on the outside of the device causes a puff of powder or vapor to be dispensed into the air, allowing the user to determine wind direction.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

The skilled person will be aware of a range of possible modifications of the various embodiments described herein. Accordingly, the present invention is defined by the claims and their equivalents.

### Detailed Description of the Drawing Figures

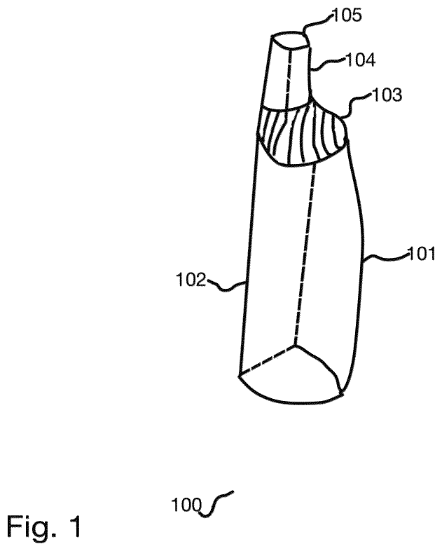

FIG. 1 is an illustration of an exemplary wind detection device according to a preferred embodiment of the invention, illustrating device design for attachment 100.

According to the embodiment, a wind detection device 100 may comprise a generally bisected cylindrical-type shape 101 (generally, a bisected cylindrical-type shape to be assembled as illustrated; however, it should be appreciated that other final shapes may be used according to a desired arrangement or use case, such as an elliptical-type shape, or an oval-type shape, or a circular-type shape, or other arrangement) with flat face 102 along the bisection for attachment to surfaces such as a hunting bow (however, it should be appreciated that device may attach to other surfaces such as longbows, recurve bows, compound bows, crossbows, guns such as rifles for rifle hunting, or string spools for kite flying, hat or visor or other devices according to a preferred arrangement or use case). Wind detection device 100 may have opaque, semi-translucent, or translucent walls 101, 102 formed of an impermeable material such as plastic (however, it should be appreciated that other materials may be used to form device walls such as (PP) Polyhigh-density polyethylene (HDPE), low-density polyethylene (LDPE), post-consumer resin (PCR), or plastic-like substances such as silicone, or polyesters such as polyethylene terephthalate (PET), or other materials according to a preferred arrangement or use case); formed where one end of device 100 narrows down to form an opening (mouth) where a lid 103 may attach to and subsequently seal device 100; and where lid 103 narrows down further to another cylindrical-type shape or conical-type shape 104 with another, smaller opening (mouth) 105 for detector contents of device to exit through when device 100 is in use. It should be noted the entire enclosure does not need to be made of the same material. In some embodiments, the enclosure will be made of a combination of materials. In some embodiments, the enclosure will be made of a combination of rigid and flexible materials. For example, in some embodiments, the enclosure may be box-shaped with one flexible wall. In other embodiments, the enclosure may have flexible sidewalls like an accordion or a bellows.

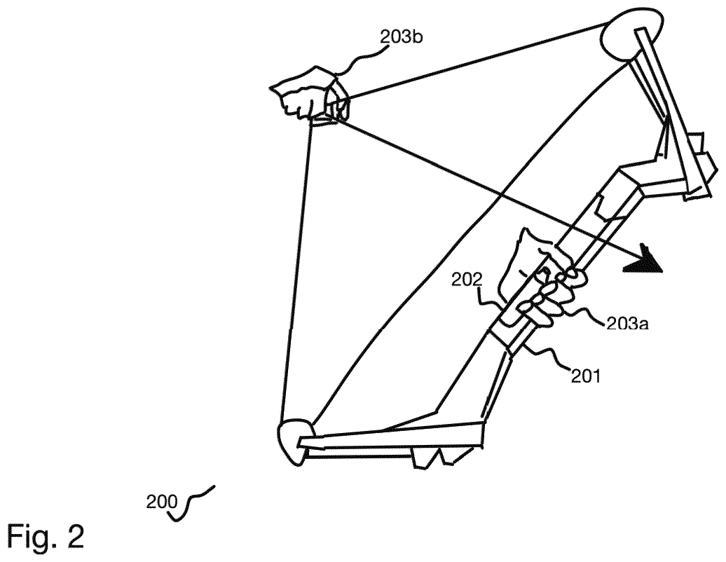

FIG. 2 is an illustration of an exemplary wind detection device according to a preferred embodiment of the invention, illustrating a hunting bow 200 with wind detection device attached. According to the embodiment, wind detection device 202 attaches directly to hunting bow 201 via an adhesive-type substance such as heavy-duty, double-sided tape (however, it should be appreciated that other adhesive substances may be used such glues, resins, strip adhesives, or other adhesives according to a preferred arrangement or use case). Adhesive is placed between desired surface location of hunting bow 201 and bisected flat surface 102 of device 202. Device 202 may be placed anywhere on hunting bow 201 according to a desired arrangement or use case of the embodiment; if device 202 is attached to hunting bow 201 near grip where hand 203a holds hunting bow 201, then hand 203a may tap or press device 202 to release detector contents such as talcum powder (generally talcum powder is used for wind detection; however, it should be appreciated that other detector contents may be used inside device such as construction chalk, baking powder, corn starch, milkweed seed pods, or micro-balloons, or other contents according to a preferred arrangement or use case), and thereby preventing the need for hand 203a to be removed from hunting bow 201 to retrieve device 202 from within hunter's pockets or bag. Attaching device 202 to hunting bow 201 also prevents need to remove hand 203b from string of hunting bow 201 which also prevents the need to reset any parts of hunting bow 201 (such as resetting an arrow).

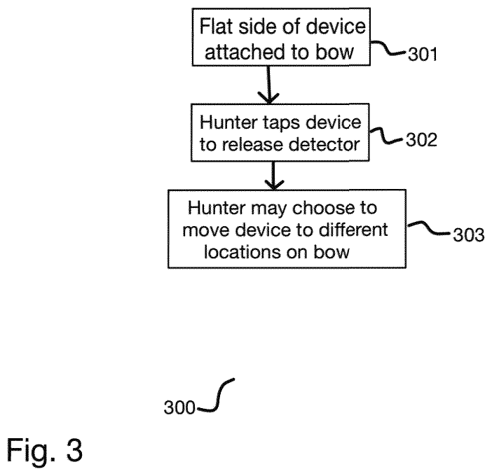

FIG. 3 is an illustration of an exemplary method diagram according to a preferred embodiment of the invention, illustrating use 300 of hands-free attachable wind detection device. In a first step, hands-free wind detection device is attached to hunting bow surface 301 along bisected flat side of device with a strong adhesive. In a next step, hunter taps or presses device to release detector contents 302 such as talcum powder into the air for wind detection. Detector contents leave device through a small opening at the top of device and float in direction of wind as well as float with the wind speed. In an optional step, hunter may choose to reattach device 303 to a different position along bow.

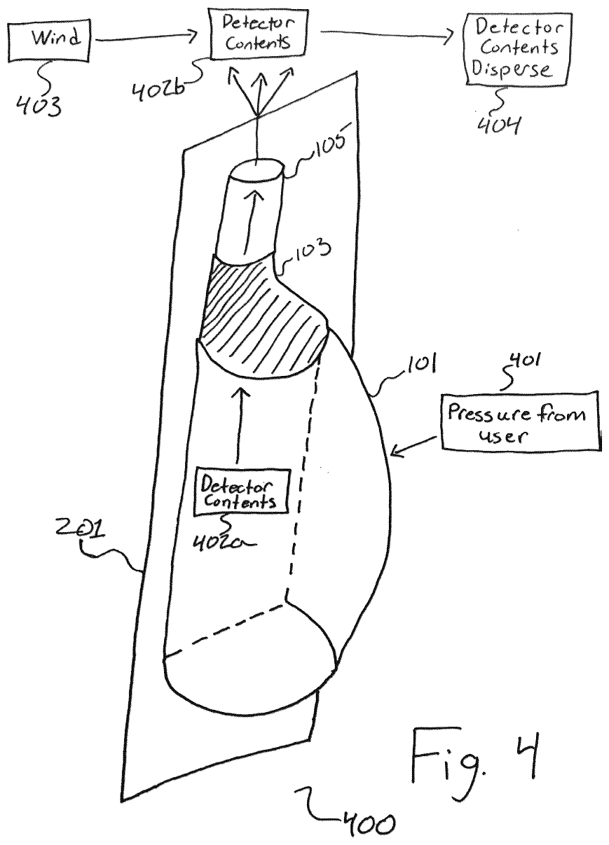

FIG. 4 is an illustration of an exemplary wind detection device according to a preferred embodiment of the invention, illustrating use 400 of wind detection device attached to surface of a hunting bow. Device 101 attaches to surface of hunting bow 201 via an adhesive placed between bisected flat surface of device 101 and surface of hunting bow 201. Detector contents 402a such as talcum powder are contained within device 101. User of device 101 such as a hunter, may apply pressure 401 to device 101 walls that are not attached to surface of hunting bow 201. The pressure 401 from user pushes device 101 walls in towards the bisected wall, thereby squeezing detector contents 402a within device 101. Detector contents 402a move from the applied pressure 401 of device 101 walls and move upwards through lid 103 and continue upward through mouth 105 of device 101. Once outside of device 101, detector contents 402b may then be subjected to wind 403; wind 403 pushes detector contents 402b along wind 403 path and thereby disperses detector contents 404. According to how detector contents 402b are dispersed 404, hunter will have a notion of which way their scent is floating with the wind 403 and will be able to make more accurate decisions regarding hunting. If there is little to no wind 403, detector contents 402b may disperse 404 by falling to the ground, hanging in the air, or gently floating around or away.

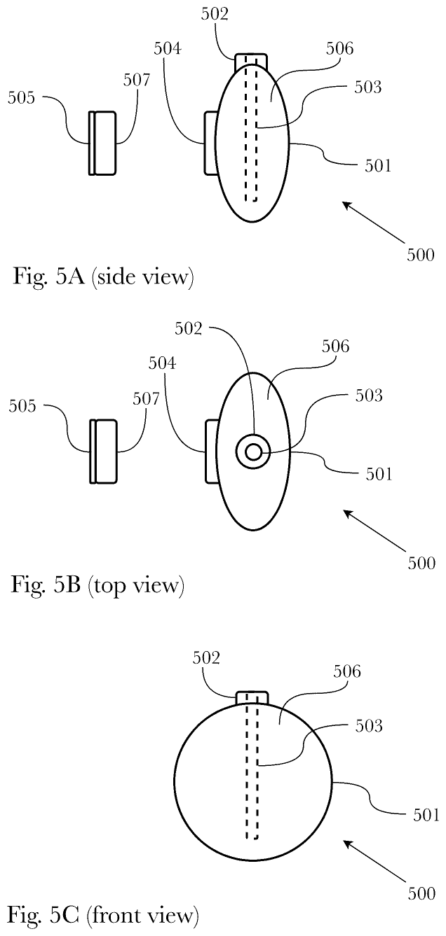

FIGS. 5A-5C are illustrations of a preferred embodiment having a circular frontal cross-section, an ovular side cross-section, and showing a mounting structure and mounting receiver. FIG. 5A shows a side view of the embodiment 500. In some embodiments, the mounting structure is removable from the enclosure, and in other embodiments, the mounting structure is permanently attached to the enclosure. In some embodiments, the mounting structure and enclosure are molded as a single piece. In this embodiment, an enclosure 501 with an interior cavity 506 has an oval shaped cross section when viewed from the side. An opening 502 at the top of the enclosure 501 allows access into the interior cavity 506 in order to fill at least a portion of the interior cavity 506 with a fine particulate substance such as talcum powder or chalk powder. When dispensed, the fine particulate substance disperses into the air, thus indicating the wind direction. In some embodiments, instead of a fine particular substance, the cavity may be filled in whole or in part by a liquid which, when dispensed, disperses as a vapor, thus indicating the wind direction. After the interior cavity 506 is filled with a particular substance, a dispensing tube 503, shown here inside the interior cavity 506, is inserted through the opening 502. The dispensing tube 503 has an opening at both ends, and a longitudinal hole running the length of the tube that connects the openings as both ends. The dispensing tube 503 is held in place by friction against the opening 502, or by grooves, ridges, tabs, or other means, such that the opening at one end of the dispensing tube 503 is inside the interior cavity 506, and the opening at the other end of the dispensing tube 503 is open to the environment outside of the enclosure 501. A mounting structure 504 is permanently affixed to the enclosure 501. A mounting receiver 507 is configured to be attached to an object, such as a hunting bow. The mounting structure 504 is configured to be removably attached to a mounting receiver 507. In this embodiment, the mounting receiver 507 is affixed to an object using an adhesive 505. The mounting structure 504 is a magnet mounted in one polarity and the mounting receiver 507 is a magnet mounted in the opposite polarity, such that the mounting structure 504 and mounting receiver 507 are attracted to one-another my magnetic attraction when placed together, holding the device in place on the object. FIG. 5B shows a top view of the same embodiment. FIG. 5C shows a front view of the same embodiment. In some embodiments, the dispensing tube is removable, and in other embodiments, the dispensing tube is permanently attached and non-removable. In some embodiments, the dispensing tube, opening, and enclosure are molded as a single piece.

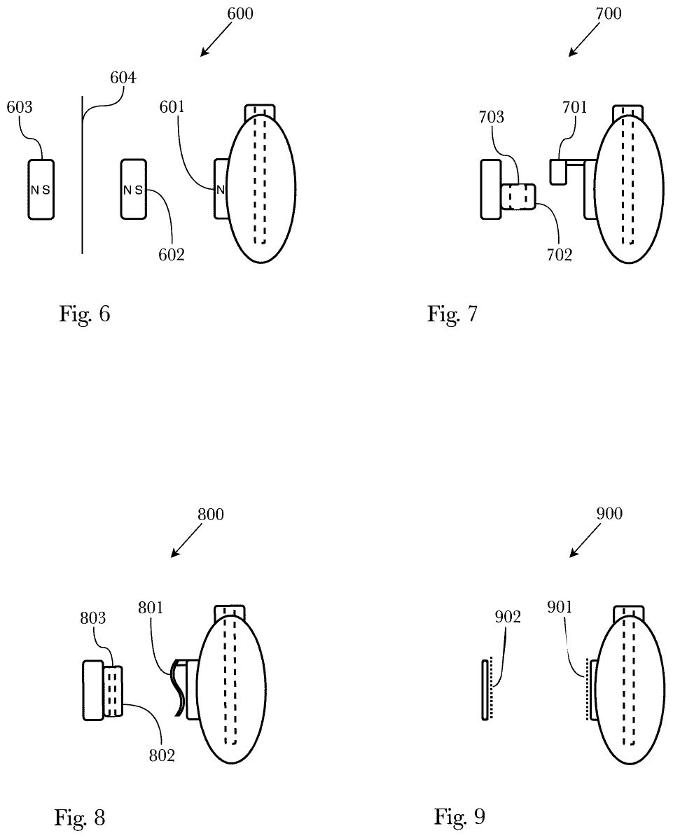

FIGS. 6-10 are illustrations of variations of the mounting structure and mounting receiver aspect. FIG. 6 shows an aspect 600 in which the device is attached through a thin object such as a hat or piece of clothing using magnets. The mounting structure 601 is a magnet of one polarity. The mounting receiver 602 is a magnet of the opposite polarity (i.e.., the magnetic polarity of the face of the mounting receiver 602 is of the opposite polarity to the face of the mounting structure 601, such that the two faces are attracted by magnetic attraction). A third magnet 603 placed behind a thin object 604 is of the opposite polarity to the magnet of the mounting receiver 602, such that the third magnet 603 and the mounting receiver 602 are held together by magnetic attraction through the thin object 604 and the device is attached to the mounting receiver 602 by the mounting structure 601, also through magnetic attraction.

An alternative embodiment may be to replace one of the magnets 601, 602 with an object made at least partly of ferrous metal, with the other object being a magnet of the appropriate polarity to pull the at-least-partially ferrous metal object to it, rather than a plurality of magnets.

FIG. 7 shows an aspect 700 in which the device is attached by a hook, post, or pin placed into a hole. The mounting structure comprises a hook, pin, or post 701. The mounting receiver comprises an extension 702 with a hole 703 into which the hook, pin or post may be inserted. The mounting receiver is attached to an object. The device is attached to the mounting receiver by inserting the hook, pin, or post 701 into the hole 703 in the mounting receiver 702.

FIG. 8 shows an aspect 800 in which the device is attached by a clip placed into a slot. The mounting structure comprises a clip 801. The mounting receiver comprises an extension 802 with a slot 803 into which the clip may be inserted. The mounting receiver is attached to an object. The device is attached to the mounting receiver by inserting the clip 801 into the hole 803 in the mounting receiver 802.

FIG. 9 shows an aspect 900 in which the device is attached by a hook and loop fastener (commonly known as velcro, and often associated with the brand name Velcro™). The mounting structure comprises one component 901 of a hook and loop fabric (e.g., the scratchy “hook” side of the hook and loop fabric), and the mounting receiver comprises the other component 902 of a hook and loop fabric (e.g., the fuzzy “loop” side of the hook and loop fabric). The mounting receiver is attached to an object. The device is attached to the mounting receiver by pressing the two components 901 and 902 of the hook and loop fabric together such that they cling to one another.

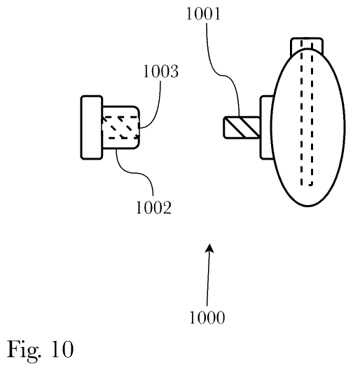

FIG. 10 shows an aspect 1000 in which the device is attached by a threaded screw mechanism. The mounting structure comprises a threaded male screw extension 1001. The mounting receiver comprises an extension 1002 with a female threaded screw opening 1003 into which the threaded male screw extension 1001 may be screwed. The mounting receiver is attached to an object. The device is attached to the mounting receiver by screwing the threaded male screw extension 1001 into the threaded female screw opening 1003 in the mounting receiver extension 1002.

It should be noted that in all of the aspects described above showing the mounting structure comprising one component of a fastening system and the mounting receiving comprising the corresponding component (e.g., male component on mounting structure/female component on mounting receiver), the reverse of each such aspect is covered by this application (e.g., female component on mounting structure/male component on mounting receiver).

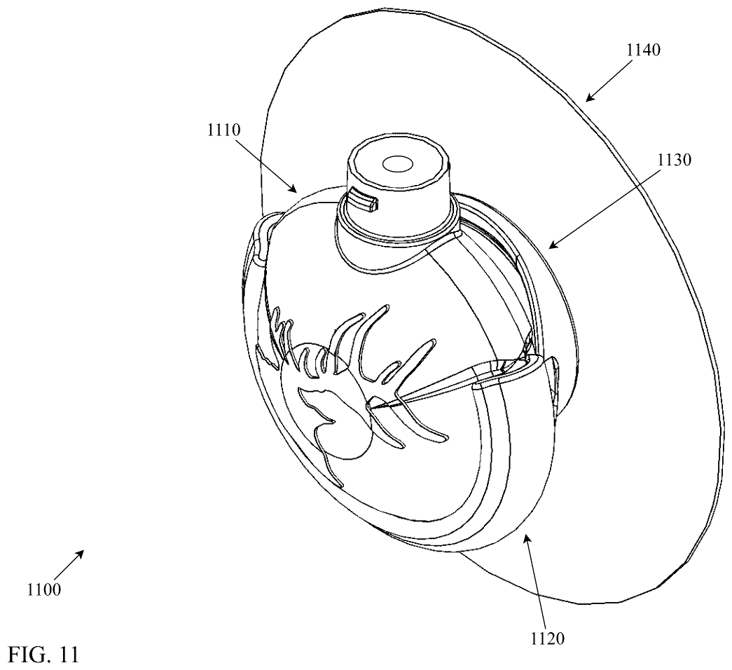

FIG. 11 shows an orthogonal front view of an exemplary embodiment of a wind detection device 1100 with a swiveling semi-circular groove-type bottle holder and attachment device. In this embodiment, the wind detection device comprises an enclosure 1110, an enclosure holder 1120, a swivel 1130, and an attachment device 1140.

The enclosure 1110 of this embodiment is a bottle having a shape comprising a roughly circular frontal cross section and a roughly ovular side cross section, and made from a flexible material such as (PP) Polyhigh-density polyethylene (HDPE), low-density polyethylene (LDPE), post-consumer resin (PCR), or plastic-like substances such as silicone, or polyesters such as polyethylene terephthalate (PET). This shape and material is convenient for dispensing of fine particulate substances as the front (or face) of the enclosure can be pressed inward, causing air pressure inside the enclosure to increase, expelling particulate matter or vapor from an opening in the enclosure 1110. In this diagram, the enclosure 1110 is shown inserted into the enclosure holder 1120.

The enclosure holder 1120 of this embodiment is a cradle having a roughly semi-circular frontal cross section of sufficient diameter to receive and hold the enclosure. The enclosure holder 1120 has an open face, allowing access to the front (or face) of the enclosure 1110 for pressing on the front (or face) of the enclosure 1110 to produce a puff of particulate matter or vapor for wind detection.

The swivel 1130 is a rotating mechanism that joins the enclosure holder 1120 and attachment device 1140, being configured to allow rotation between the enclosure holder 1120 (and the enclosure 1110 when mounted inside) and the attachment device on a plane roughly parallel to a surface of hunting equipment, outdoor gear, outdoor structures, headgear, or clothing. In an embodiment, the wind detection device comprises an enclosure filled with powder or liquid, an enclosure holder, a swivel, and an attachment device, and a dispensing tube, designed to be attached to hunting equipment, outdoor gear, outdoor structures, headgear, or clothing, wherein pressing on the outside of the device causes a puff of powder or vapor to be dispensed into the air, allowing the user to determine wind direction.on which the attachment device 1140 is attached. The purpose of the swivel is to allow the enclosure 1110 and enclosure holder 1120 to be adjusted to an upright or other appropriate orientation for use regardless of the position of the object to which it is attached.

The attachment device 1140 of this embodiment comprises an attachment surface which may be used to mount the enclosure 1110 and the enclosure holder 1120 to hunting equipment, outdoor gear, outdoor structures, headgear, or clothing.

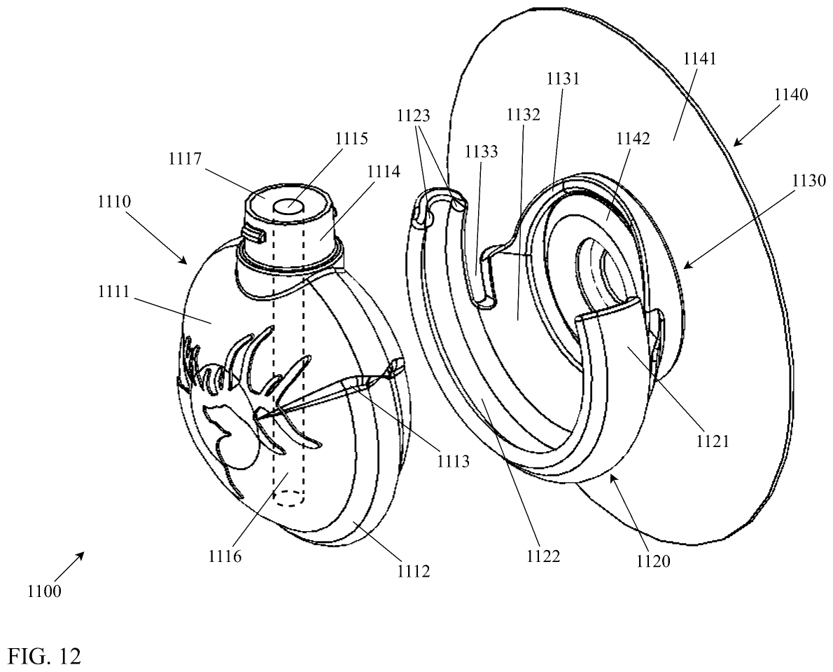

FIG. 12 shows an exploded orthogonal front view of an exemplary embodiment of a wind detection device 1100 with a swiveling semi-circular groove-type bottle holder and attachment device.

The enclosure 1110 of this embodiment is a bottle having a roughly circular frontal cross section and a roughly ovular side cross section and made from a flexible material such as (PP) Polyhigh-density polyethylene (HDPE), low-density polyethylene (LDPE), post-consumer resin (PCR), or plastic-like substances such as silicone, or polyesters such as polyethylene terephthalate (PET). This shape and material is convenient for dispensing of fine particulate substances as the front (or face) of the enclosure 1111 can be pressed inward, causing air pressure inside the enclosure to increase, expelling particulate matter or vapor from an opening 1115 at one end of a dispensing tube 1116. A removable plug 1117 with attached dispensing tube 1116 at the top of the enclosure 1110 allows access into an interior cavity of the enclosure in order to fill at least a portion of the interior cavity with a fine particulate substance such as talcum powder or chalk powder. A collar 1114 is configured to receive the removable plug 1117 with its dispensing tube 1116. The collar 1114 may be a cylindrical shape as shown in this diagram, or may be of other suitable shapes such as a simple hole or opening, or a hole or opening with a reinforced ring around its circumference. When dispensed, the fine particulate substance disperses into the air, thus indicating the wind direction. In some embodiments, instead of a fine particular substance, the cavity may be filled in whole or in part by a liquid which, when dispensed, disperses into the air as a vapor, thus indicating the wind direction. After the interior cavity is filled with a particular substance, the removeable plug 1117 with dispensing tube 1116 is re-inserted into the top of the enclosure 1110. The dispensing tube 1116 has an opening at both ends, and a longitudinal hole running the length of the tube that connects the openings as both ends. The removable plug 1117 with dispensing tube 1116 is held in place by friction against the opening 1115, or by grooves, ridges, tabs, or other means, such that the opening at one end of the dispensing tube 1116 is inside the interior cavity, and the opening at the other end of the dispensing tube is open to the environment outside of the enclosure. In some embodiments, the dispensing tube 1116 may be a separate component from the removable plug 1117. In some embodiments, the dispensing tube 1116 may be removable and the plug 1117 may not be removable.

The enclosure 1110 may further have notches, indentations, or tabs 1113 configured to engage with corresponding notches, indentations, or tabs of the enclosure holder 1120, the purpose of which is to provide additional security of retention of the enclosure 1110 when inserted into the enclosure holder 1120. The enclosure 1110 may further have protruding or indenting ridges 1112 formed into it along the bottom and sides of the enclosure's 1110 exterior circumference configured to fit into corresponding protruding or indenting ridges 1122 in the enclosure holder's 1120 interior circumference, the purpose of which is to ensure proper alignment of the enclosure 1110 and the enclosure holder 1120 to provide additional security and stability between the enclosure 1110 and the enclosure holder 1120 to prevent rotation and slippage.

It should be noted the entire enclosure does not need to be made of the same material. In some embodiments, the enclosure will be made of a combination of materials. In some embodiments, the enclosure will be made of a combination of rigid and flexible materials. For example, in some embodiments, the enclosure may be formed of mostly rigid materials with one flexible wall (for example, a flexible front face). In other embodiments, the enclosure may have flexible sidewalls like an accordion or a bellows.

The enclosure holder 1120 of this embodiment is a cradle having a shape comprising a roughly semi-circular frontal cross section of sufficient interior diameter to receive and hold the exterior diameter of the enclosure. The enclosure holder 1120 has an open face, allowing access to the front (or face) of the enclosure 1110 for pressing on the front 1111 of the enclosure 1110 to produce a puff of particulate matter or vapor for wind detection. The roughly semi-circular shape 1121 of the enclosure holder 1120 extends up from the bottom more than halfway (i.e., forms a roughly circular shape (or arc) of 180 degrees or more but less than 360 degrees) such that the enclosure holder prevents the enclosure 1110 from falling out or other accidental loss or release by enclosing 180 degrees or more of the circumference of the enclosure 1110 (i.e., wraps around the bottom, sides, and a portion of the upper circumference). Insertion of the enclosure 1110 into the enclosure holder 1120 is facilitated by notches 1133 in a portion of the enclosure holder allowing flexion and movement of the upper portions 1121 of the roughly semi-circular shape, allowing the enclosure to be pressed downward between them into the enclosure holder 1120, with the upper portions 1121 of the semi-circular shape helping to retain the enclosure 1110 and prevent it from falling out or other accidental loss or release from the enclosure holder 1120. In some embodiments, only a single upper portion 1121 is flexible. In some embodiments, the notches 1133 are not required as the upper portions 1121 are either made of sufficiently flexible material so that the notches 1133 are not needed, or the upper portions 1121 are designed to be long enough to provide sufficient flexion without them.

The enclosure holder 1120 of this embodiment is further mounted on, attached to, or formed as a piece of, the swivel 1130, allowing for the enclosure 1110 and enclosure holder 1120 to be adjusted to an upright or other appropriate orientation for use regardless of the position of the object to which it is attached. In some embodiments, the enclosure 1110 and/or the enclosure holder 1120 may be weighted on their bottom portions to allow the force of gravity to automatically maintain the enclosure 1110 and enclosure holder 1120 in an upright or other appropriate orientation for use regardless of the position of the object to which it is attached.

The enclosure holder 1120 may further have notches, indentations, or tabs 1123 configured to engage with corresponding notches, indentations, or tabs 1113 of the enclosure 1110, the purpose of which is to provide additional security of retention of the enclosure 1110 when inserted into the enclosure holder 1120. The enclosure holder 1120 may further have protruding or indenting ridges 1122 formed into the enclosure holder's 1120 interior circumference configured to fit into corresponding protruding or indenting ridges 1112 along the bottom and sides of the enclosure's 1110 exterior circumference, the purpose of which is to ensure proper alignment of the enclosure 1110 and the enclosure holder 1120 to provide additional security and stability between the enclosure 1110 and the enclosure holder 1120 to prevent rotation and slippage.

The swivel 1130 is a rotating mechanism that joins the enclosure holder 1120 and attachment device 1140, being configured to allow rotation between the enclosure holder 1120 (and the enclosure 1110 when mounted inside) and the attachment device on a plane roughly parallel to a surface of hunting equipment, outdoor gear, outdoor structures, headgear, or clothing on which the attachment device 1140 is attached (in this diagram, the plane roughly parallel to a surface is the same plane as the attachment surface 1141). The purpose of the swivel 1130 is to allow the enclosure 1110 and enclosure holder 1120 to be adjusted to an upright or other appropriate orientation for use regardless of the position of the object to which it is attached. In some embodiments, the enclosure 1110 and/or the enclosure holder 1120 may be weighted on their bottom portions to allow the force of gravity to automatically maintain the enclosure 1110 and enclosure holder 1120 in an upright or other appropriate orientation for use regardless of the position of the object to which it is attached. For example, if the attachment device 1140 is attached to the side of a hunting bow, when the bow is raised from a horizontal position (e.g., when walking) to an upright position (e.g., when preparing to draw and fire), if the enclosure 1110 is not in an upright or other appropriate orientation for use, it may be rotated to such an orientation prior to operation for wind detection.

This drawing also shows the connection 1132 between the enclosure holder 1120 and the swivel 1130. In this embodiment, the enclosure holder 1120 and the outside portion 1131 of the swivel 1130 are molded as a single piece. In other embodiments, a different means of connection 1132 may be used between the enclosure holder 1120 and the outside portion 1131 of the swivel 1130, such as a removable, snap-together connection. The inside portion 1142 of the swivel 1130 is attached to the attachment device 1140. In this embodiment, the inside portion 1142 of the swivel 1130 is press-fitted through the outside portion 1132 of the swivel 1130 through an opening in the attachment device 1140. In other embodiments, a different means of connection may be used between the inside portion 1142 of the swivel 1130 and the attachment device 1140.

The attachment device 1140 of this embodiment comprises an attachment surface 1141 which may be used to mount the enclosure 1110 and the enclosure holder 1120 to hunting equipment, outdoor gear, outdoor structures, headgear, or clothing. The attachment surface 1141 may be rigid or flexible. A rigid attachment surface 1141, such as a hard plastic or metal disc, would be suitable for attachment to flat surfaces such as ammunition boxes. A flexible attachment surface (e.g., a flexible rubber or silicone disc) allows the attachment surface to follow the contours of a curved surface of hunting equipment, outdoor gear, outdoor structures, headgear, or clothing (e.g., a curved portion of a hunting bow or a curved portion of the stock of a hunting rifle). In some embodiments, the attachment device 1140 may be attached to the hunting equipment, outdoor gear, outdoor structures, headgear, or clothing using adhesives or other press-fit devices like hook and loop fabrics (such as Velcro®). In other embodiments, the attachment device may comprise a strap which may be wrapped around a portion of hunting equipment, outdoor gear, outdoor structures, headgear, or clothing such as string, wire, zip ties, leather or fabric straps with buckles, straps comprising hook and loop fabrics, etc.

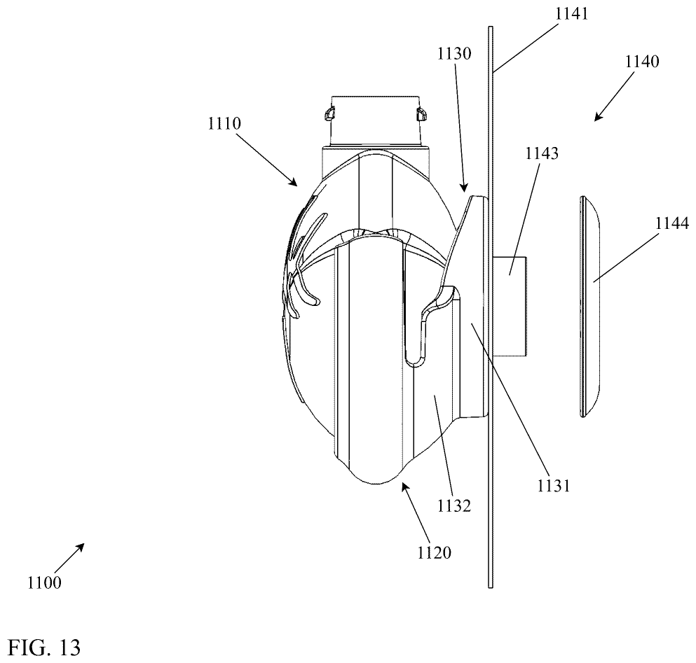

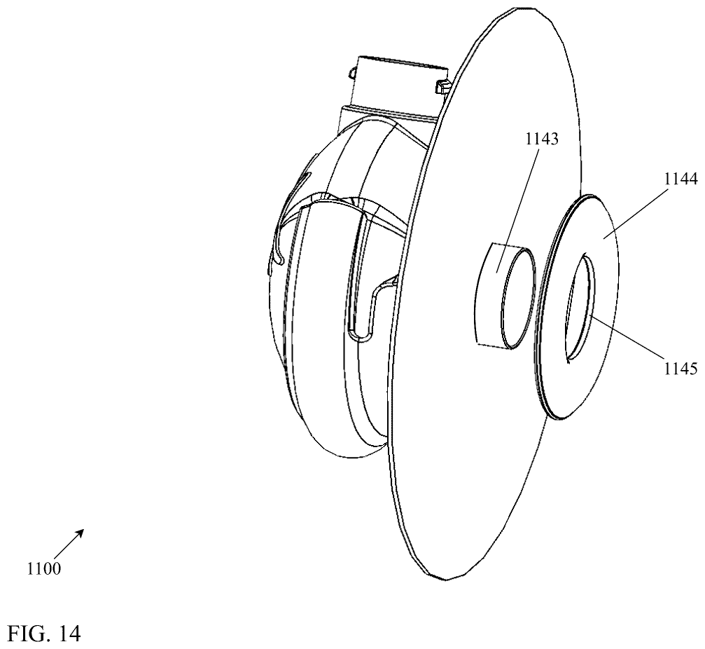

FIG. 13 shows a partially-exploded side view of an exemplary embodiment of a wind detection device 1100 with a swiveling semi-circular groove-type bottle holder and attachment device. In this embodiment, the wind detection device comprises an enclosure 1110, an enclosure holder 1120, a swivel 1130, and an attachment device 1140. This drawing shows additional detail regarding the connection 1132 between the enclosure holder 1120 and the swivel 1130. In this embodiment, the enclosure holder 1120 and the outside portion 1131 of the swivel 1130 are molded as a single piece. In other embodiments, a different means of connection 1132 may be used between the enclosure holder 1120 and the outside portion 1131 of the swivel 1130, such as a removable, snap-together connection. The inside portion 1142 of the swivel 1130 is attached to the attachment device 1140. In this embodiment, the inside portion 1142 of the swivel 1130 is press-fitted through the outside portion 1132 of the swivel 1130 through an opening in the attachment device 1140. This drawing shows the rear portion 1143 of the inside portion 1142 of the swivel protruding through an opening in the attachment surface 1141 and a press-fit ring retention component 1144 that fits on the rear portion 1143 and retains the inside portion 1142 of the swivel in place. In other embodiments, a different means of connection may be used between the inside portion 1142 of the swivel 1130 and the attachment device 1140.

FIG. 14 shows a partially-exploded orthogonal rear view of an exemplary embodiment of a wind detection device 1100 with a swiveling semi-circular groove-type bottle holder and attachment device. This drawing shows additional detail regarding the rear portion 1143 of the inside portion 1142 of the swivel 1130. In particular, this drawing shows the opening 1145 in the retention ring 1144 that is press-fit over the rear portion 1143 of the inside portion 1142 of the swivel 1130.

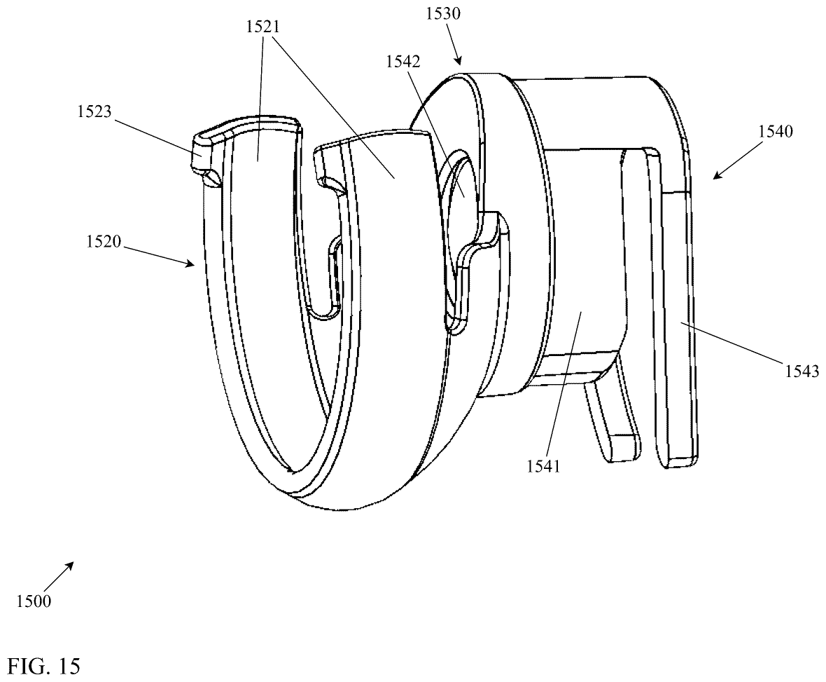

FIG. 15 shows an orthogonal front view of an alternate exemplary embodiment of a wind detection device 1500 with a swiveling semi-circular groove-type bottle holder and attachment device. In this embodiment, the wind detection device comprises an enclosure (not shown) with characteristics similar to those of enclosure 1110 of a previous embodiment, an enclosure holder 1520 with characteristics similar to those of enclosure 1120 of a previous embodiment, a swivel 1530, and an attachment device 1540.

The enclosure holder of this embodiment has extensions 1523 on the upper portions 1521 of the arc of the enclosure holder to aid in retention of the enclosure (not shown) when inserted into the enclosure holder 1520. The extensions may be of various types or shapes, including but not limited to tabs, wings, and nubs.

The swivel 1530 of this embodiment has characteristics similar to those of enclosure 1130 of a previous embodiment except that the inside portion of the swivel 1530 is a round-headed nut 1542 with threading configured to screw onto a corresponding bolt 1543 at the back of the attachment device.

The attachment device 1540 of this embodiment is a clip-on attachment device comprising a body 1541 affixed to the swivel via the nut 1542 and bolt 1543 and one or more clip arms 1543 for clipping to any suitable edge or other protrusion of hunting equipment, outdoor gear, outdoor structures, headgear, or clothing. For example, the clip arms 1543 may be clipped over the top edge of a pocket of a shirt, the top edge of a pocket of a pair of pants, the bill of a cap, or to any suitable protrusion on a hunting bow or rifle.

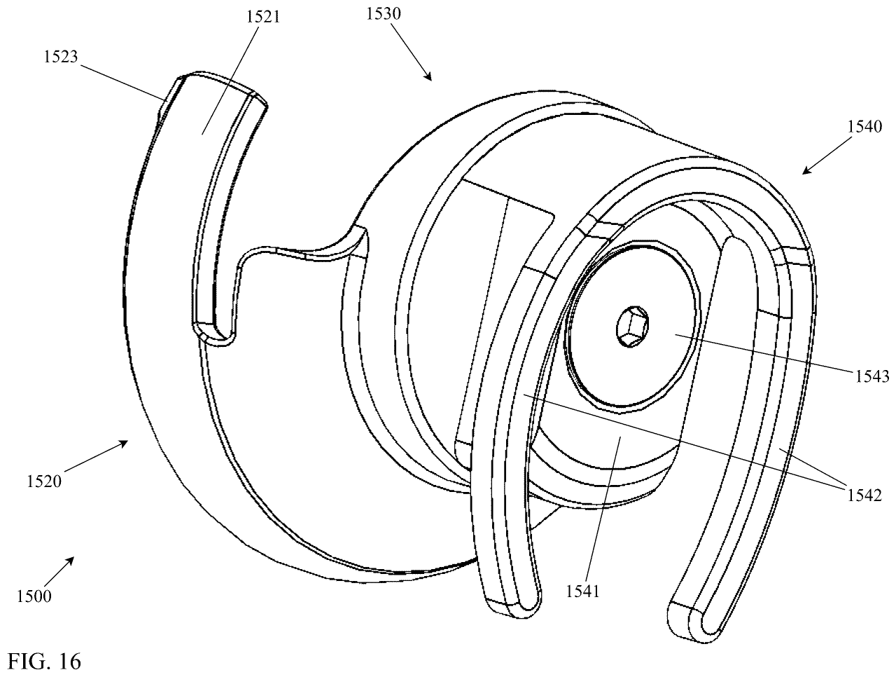

FIG. 16 shows an orthogonal rear view of an alternate exemplary embodiment of a wind detection device 1500 with a swiveling semi-circular groove-type bottle holder and attachment device. This embodiment is the same as that in FIG. 15. This drawing also shows the bolt 1543 which attaches the body 1541 of the attachment device 1540 by screwing into the nut 1542 on the front side of the swivel 1530.

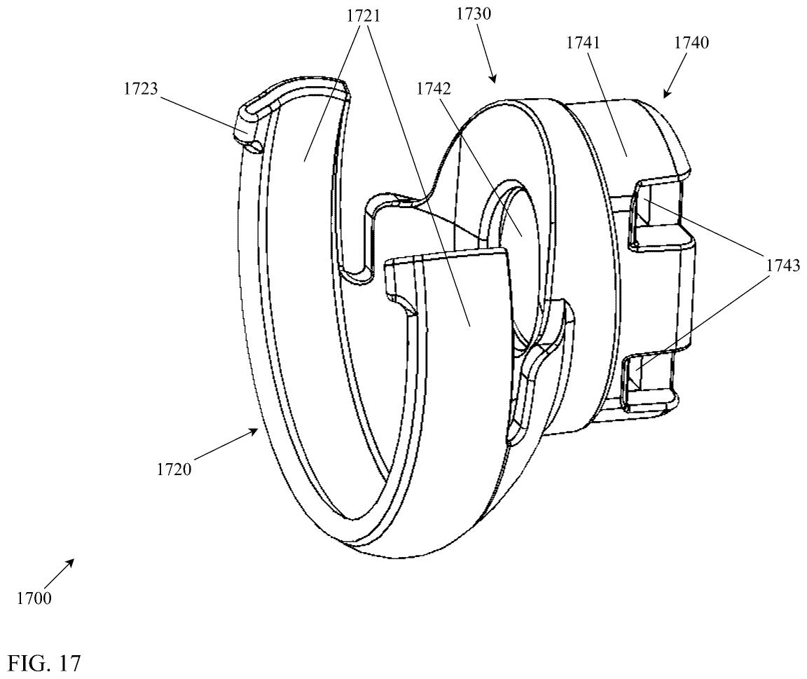

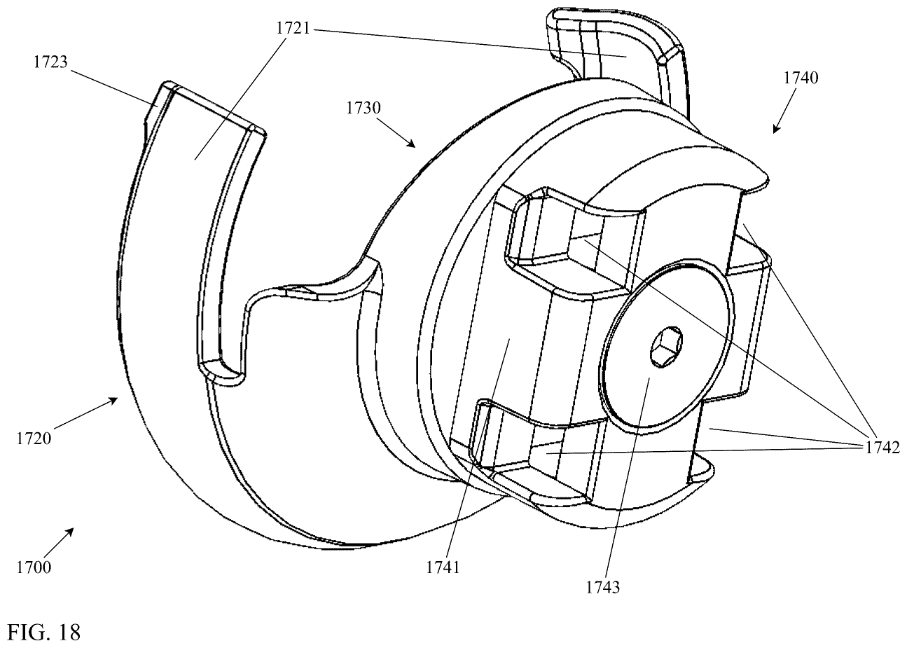

FIG. 17 shows an orthogonal front view of an alternate exemplary embodiment of a wind detection device 1700 with a swiveling semi-circular groove-type bottle holder and attachment device. In this embodiment, the wind detection device comprises an enclosure (not shown) with characteristics similar to those of enclosure 1110 of a previous embodiment, an enclosure holder 1720 with characteristics similar to those of enclosure 1120 of a previous embodiment, a swivel 1730, and an attachment device 1740.

The enclosure holder of this embodiment has extensions 1723 on the upper portions 1721 of the arc of the enclosure holder to aid in retention of the enclosure (not shown) when inserted into the enclosure holder 1720. The extensions may be of various types or shapes, including but not limited to tabs, wings, and nubs.

The swivel 1730 of this embodiment has characteristics similar to those of enclosure 1130 of a previous embodiment except that the inside portion of the swivel 1730 is a round-headed nut 1742 with threading configured to screw onto a corresponding bolt 1743 at the back of the attachment device.

The attachment device 1740 of this embodiment is a strap-on attachment device comprising a body 1741 affixed to the swivel via the nut 1742 and bolt 1743 and one or more holes 1743 for insertion of a strap which may be wrapped around a portion of hunting equipment, outdoor gear, outdoor structures, headgear, or clothing. Examples of straps that may be inserted through the one or more holes 1743 include, but are not limited to strings, wires, zip ties, leather or fabric straps with buckles, straps comprising hook and loop fabrics, etc. For example, zip ties may be inserted through the pair of holes shown 1743, wrapped around a hunting bow or the stock of a hunting rifle and closed using the zip tie mechanism, thus securing the attachment device 1740 to the bow or hunting rifle.

FIG. 18 shows an orthogonal rear view of an alternate exemplary embodiment of a wind detection device with a swiveling semi-circular groove-type bottle holder and attachment device. This embodiment is the same as that in FIG. 17. This drawing also shows the bolt 1743 which attaches the body 1741 of the attachment device 1740 by screwing into the nut 1742 on the front side of the swivel 1730.

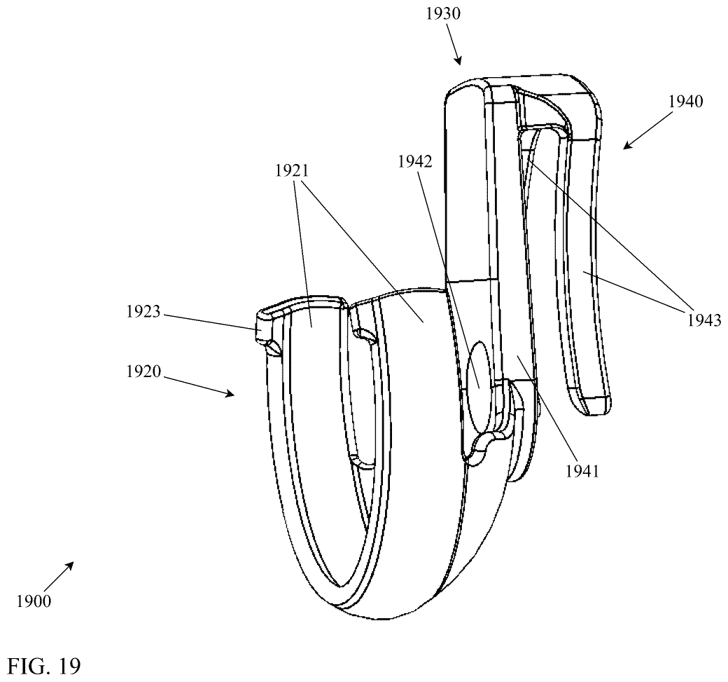

FIG. 19 shows an orthogonal front view of an alternate exemplary embodiment of a wind detection device 1900 with a swiveling semi-circular groove-type bottle holder and attachment device. In this embodiment, the wind detection device comprises an enclosure (not shown) with characteristics similar to those of enclosure 1110 of a previous embodiment, an enclosure holder 1920 with characteristics similar to those of enclosure 1120 of a previous embodiment, a swivel 1930, and an attachment device 1940. This embodiment is similar to that of FIG. 15, but with a slimmer body 1941 profile.

The enclosure holder of this embodiment has extensions 1923 on the upper portions 1921 of the arc of the enclosure holder to aid in retention of the enclosure (not shown) when inserted into the enclosure holder 1920. The extensions may be of various types or shapes, including but not limited to tabs, wings, and nubs.

The swivel 1930 of this embodiment has characteristics similar to those of enclosure 1130 of a previous embodiment except that the inside portion of the swivel 1930 is a round-headed nut with threading (not shown) configured to screw onto a corresponding bolt (not shown) at the back of the attachment device.

The attachment device 1940 of this embodiment is a clip-on attachment device comprising a body 1941 affixed to the swivel via the nut (not shown) and bolt (not shown) and one or more clip arms 1943 for clipping to any suitable edge or other protrusion of hunting equipment, outdoor gear, outdoor structures, headgear, or clothing. For example, the clip arms 1943 may be clipped over the top edge of a pocket of a shirt, the top edge of a pocket of a pair of pants, the bill of a cap, or to any suitable protrusion on a hunting bow or rifle. The body 1941 of this embodiment is thinner than that of FIG. 15 and is designed cause the enclosure holder to sit closer to the object to which it is attached.

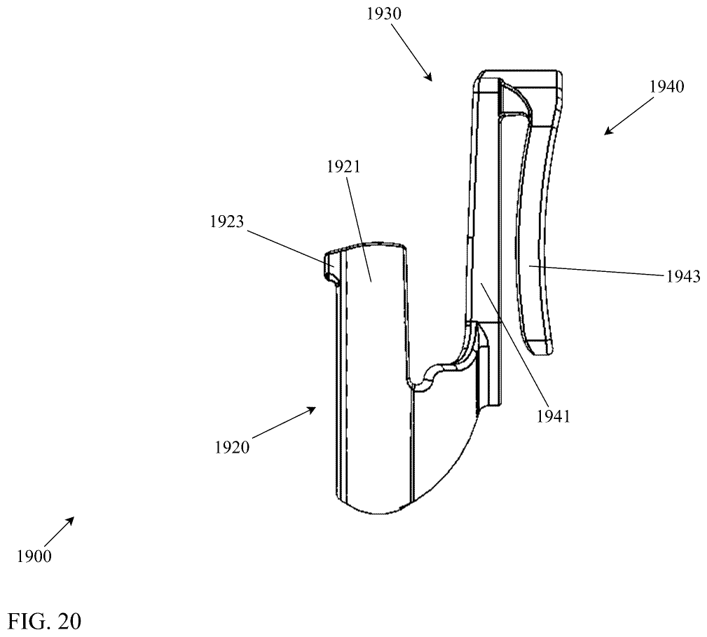

FIG. 20 shows a side elevation view of an alternate exemplary embodiment of a wind detection device 1900 with a swiveling semi-circular groove-type bottle holder and attachment device. This embodiment is the same as that in FIG. 19. This drawing also shows the bolt 1943 which attaches the body 1941 of the attachment device 1940 by screwing into the nut 1942 on the front side of the swivel 1930.

What is claimed is:

1. A wind detection device, comprising:
an enclosure with a roughly circular frontal cross section having an exterior diameter and a roughly ovular side cross section, the enclosure comprising:
an interior cavity;
a flexible front wall, and an attachment device;
a collar configured to allow insertion and retention of a removable plug and dispensing tube;
the removable plug and dispensing tube inserted into and retained in the collar, the dispensing tube having a first and a second end, with the first end extending through the opening into the interior cavity, and with a longitudinal hole extending the length of the dispensing tube from the first end to the second end;
an enclosure holder comprising:
a roughly semi-circular frontal shape of sufficient interior diameter to receive and hold the exterior diameter of the enclosure, wherein the roughly semi-circular cross shape of the enclosure holder describes an arc of 180 degrees or more but less than 360 degrees; and
at least one upper portion of the roughly semi-circular frontal shape of the enclosure holder is configured to be sufficiently flexible to allow insertion of the enclosure into the enclosure holder;
an attachment device configured to allow attachment of the enclosure holder to an object, and a swivel joining the enclosure holder and attachment device and configured to allow rotation between the enclosure holder and the attachment device.

2. The wind detection device of claim 1, further comprising one or more notches, indentations, or tabs on the enclosure configured to engage with corresponding one or more notches, indentations, or tabs of the enclosure holder to aid in retention of the enclosure when inserted into the enclosure holder.

3. The wind detection device of claim 1, further comprising one or more extensions on one or more of the upper portions of the arc of the enclosure holder to aid in retention of the enclosure when inserted into the enclosure holder.

4. The wind detection device of claim 1, wherein the attachment device further comprises an attachment surface for attachment of the wind detection device to an object using adhesives.

5. The wind detection device of claim 4, wherein the attachment surface is a disc of rigid material.

6. The wind detection device of claim 4, wherein the attachment surface is a disc of flexible material.

7. The wind detection device of claim 1, wherein the attachment device is a clip-on device comprising a body affixed to the swivel and one or more clip arms for clipping to a suitable edge or other protrusion of an object.

8. The wind detection device of claim 1, wherein the attachment device is a strap-on attachment device comprising a body affixed to the swivel and one or more holes for insertion of a strap for wrapping around an object or portion of an object.
